(19) United States
(12) Patent Application Publication
(10) Pub. No.: US 2011/0123372 A1
(43) Pub. Date: May 26, 2011

(54) VANE PUMP AND EVAPORATIVE LEAK CHECK SYSTEM HAVING THE SAME

(75) Inventors: Tomohiro Itoh, Takahama-city (JP); Mitsuyuki Kobayashi, Gamagori-city (JP); Shinji Sugihara, Mizuho-city (JP)

(73) Assignee: DENSO CORPORATION, Kariya-city (JP)

(21) Appl. No.: 12/941,125

(22) Filed: Nov. 8, 2010

(30) Foreign Application Priority Data
Nov. 24, 2009 (JP) 2009-266528

(51) Int. Cl. F04B 35/04; G01M 3/20

(52) U.S. Cl. 417/410.1; 73/40.7

(57) ABSTRACT

An upper casing and a lower casing cooperate together to define a pump chamber, in which a rotor is rotatably received. A surface of the lower casing, which is opposed to one end surface of the rotor in an axial direction of the rotor, has a recess that is recessed for a predetermined amount away from the rotor in the axial direction of the rotor. A surface of a plate portion of the upper casing, which is opposed to the other end surface of the rotor in the axial direction of the rotor, has a recess that is recessed for a predetermined amount away from the rotor in the axial direction of the rotor. An outer peripheral edge of each of the recesses is placed radially inward of an outer peripheral edge of the rotor in an axial view of the rotor.

### CROSS REFERENCE TO RELATED APPLICATION

This application is based on and incorporates herein by reference Japanese Patent Application No. 2009-266528 filed on Nov. 24, 2009.

### BACKGROUND OF THE INVENTION

1. Field of the Invention

The present invention relates to a vane pump and an evaporative leak check system having the same.

2. Description of Related Art

In a known vane pump, a rotor having a plurality of vanes is rotated to pressurize and discharge fluid upon pressurization thereof. For example, Japanese Unexamined Patent Publication No. 2009-138602 (corresponding to US 2009/0148329A1) teaches such a vane pump that is used to depressurize or pressurize an interior of a fuel tank in an evaporative leak check system that is used to check leakage of fuel vapor from the fuel tank. The performance of the evaporative leak check system is often influenced by a pump performance of the vane pump.

In this vane pump, a generally cylindrical rotor is placed in a pump chamber, which is defined by an upper casing and a lower casing. A shaft of an electric motor is loosely received in a center hole of the rotor in a manner that enables rotation of the rotor together with the shaft. When the motor is driven to rotate the shaft, the rotor is rotated in the pump chamber in response to the rotation of the shaft. At this time, the rotor slides on a surface of the lower casing, which is opposed to the rotor, and also slides on a surface of the upper casing, which is opposed to the rotor. Therefore, it is desirable that the slide surface of the lower casing and the slide surface of the upper casing, which slide, relative to the rotor, have a high degree of planarity.

However, depending on the finishing quality at the time of molding, a prominent surface roughness (waviness) is generated on the slide surface of the lower casing and/or the slide surface of the upper casing, which slide relative to the rotor. For example, a center part of the lower casing, which is opposed to the end surface of the rotor, may sometimes have the prominent surface roughness (waviness) to protrude toward the rotor side. In such a case, a corresponding center part of the rotor slides on the protruded center part of the rotor. Thereby, the rotor may be wobbled about the center axis of the shaft of the motor, which is loosely received in the center hole of the rotor, and thereby the position, i.e., posture of the rotor becomes unstable. When the posture of the rotor becomes unstable during the rotation of the rotor, the performance of the pump may be changed. Also, in the case where the degree of the surface roughness (waviness) is large, the rotor and the lower casing may be locally worn to cause locking of the rotation of the rotor.

It is possible to remove the roughness (waviness), which is generated in the slide surface of the lower casing and the slide surface of the upper casing, by, for example, a cutting process with a cutting tool to increase the degree of the planarity of the slide surfaces. In this way, it is possible to maintain the stable pump performance. However, in such a case, the manufacturing costs are disadvantageously increased.

### SUMMARY OF THE INVENTION

The present invention is made in view of the above disadvantages. According to the present invention, there is provided a vane pump, which includes an upper casing, a lower casing, a rotor and an electric motor. The upper casing is cup-shaped and thereby includes a tubular portion and a plate portion. The plate portion is generally planar and closes an opening of one end part of the tubular portion. The lower casing is generally planar and closes an opening of the other end part of the tubular portion, which is opposite from the one end part of the tubular portion, to form a pump chamber in corporation with the plate portion and the tubular portion. The rotor is generally cylindrical and is rotatably received in the pump chamber. The rotor includes a center hole, which penetrates through a center part of the rotor in an axial direction of the rotor, and a plurality of vanes, which are slidable along an inner peripheral wall of the tubular portion upon rotation of the rotor. The electric motor has a shaft, which is loosely received in the center hole of the rotor. The electric motor is driven to rotate the rotor through rotation of the shaft upon receiving electric power. At least one of a surface of the lower casing and a surface of the plate portion, each of which is opposed to a corresponding end surface of the rotor in the axial direction of the rotor, has a recess that is recessed for a predetermined amount away from the rotor in the axial direction of the rotor. An outer peripheral edge of the recess of the at least one of the surface of the lower casing and the surface of the plate portion is placed radially inward of an outer peripheral edge of the rotor in an axial view of the rotor.

According to the present invention, there is also provided an evaporative leak check system including the vane pump discussed above. The vane pump is adapted to depressurize or pressurize an interior of the fuel tank to check leakage of fuel vapor from the fuel tank.

### BRIEF DESCRIPTION OF THE DRAWINGS

The invention, together with additional objectives, features and advantages thereof, will be best understood from the following description, the appended claims and the accompanying drawings in which:

FIG. 1 is a schematic cross sectional view of a vane pump according to a first embodiment of the present invention;

FIG. 2 is a cross sectional view taken along line in FIG. 1;

FIG. 3 is a plan view of a resilient sheet of the vane pump according to the first embodiment;

FIG. 4 is a schematic cross-sectional view showing a portion of the vane pump of the first embodiment;

FIG. 5 is a schematic diagram showing an evaporative leak check system having the vane pump of the first embodiment; and

FIG. 6 is a schematic cross sectional view of a vane pump according to a second embodiment of the present invention.

### DETAILED DESCRIPTION OF THE INVENTION

Embodiments of the present invention will be described with reference to the accompanying drawings. In the following embodiments, similar components will be indicated by the same reference numerals and will not be described redundantly for the sake of simplicity.

### First Embodiment

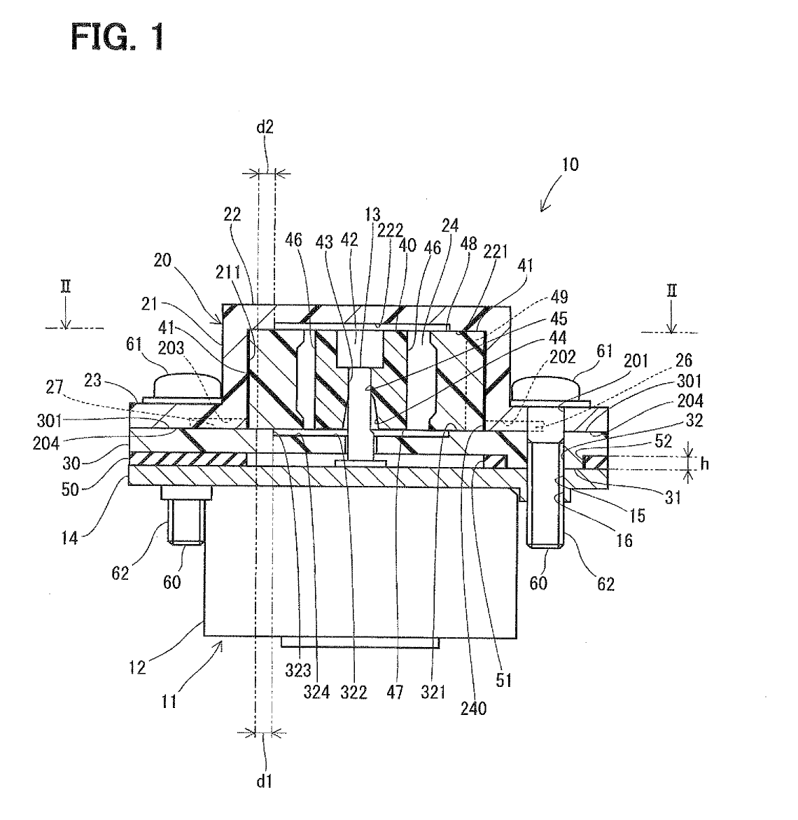

FIGS. 1 to 4 show a vane pump according to a first embodiment of the present invention. The vane pump 10 pressurizes fluid upon drawing the same and discharges the pressurized fluid. The fluid to be pressurized by the vane pump 10 may be any appropriate fluid, such as gas (e.g., air) or liquid (e.g., water).

The vane pump 10 includes an upper casing 20, a lower casing 30, a rotor 40 and an electric motor 11. The rotor 40 of the vane pump 10 is driven by the motor 11, which is placed such that the lower casing 30 and a resilient sheet (elastic sheet) 50 are held between the rotor 40 and the motor 11. The motor 11 may be a direct current electric motor or an alternating current electric motor. The motor 11 includes a cover (housing) 12, a shaft 13 and a mount portion 14. The cover 12 receives a stator (not shown). The shaft 13 is rotatable together with a rotor (not shown) received in the cover 12. The upper casing 20, the lower casing 30 and the resilient sheet 50 are installed to the mount portion 14.

The upper casing 20 includes a tubular portion 21, a plate portion 22 and a flange portion 23 and is formed integrally from, for example, a resin material. The tubular portion 21 is configured into a generally cylindrical tubular form. An inner peripheral wall 211 of the tubular portion 21 is configured to have a generally cylindrical surface. An opening of one end part of the tubular portion 21 is closed with the plate portion 22, which is generally planar. The flange portion 23 is formed at the other end part of the tubular portion 21 to radially outwardly project. A planar surface portion (serving as a primary planar surface portion) 204 is formed in an end surface of the flange portion 23, which is opposite from the plate portion 22 in the axial direction. Thereby, the upper casing 20 is configured into the cup-shaped body having the peripheral wall (wall of the tubular portion 21) and the bottom wall (wall of the plate portion 22).

The lower casing 30 is configured into a plate form (i.e., being generally planar) and is made of, for example, a resin material. A planar surface portion (serving as a secondary planar surface portion) 301 is formed in an end surface of the lower casing 30, which is located on the upper casing 20 side in the axial direction. The planar surface portion 301 is securely connected to or joined to the planar surface portion 204 of the upper casing 20. In this way, the lower casing 30 covers an opening at the other end part of the tubular portion 21, which is opposite from the one end part of the tubular portion 21 in the axial direction. Thereby, at a radially inner side of the tubular portion 21, a pump chamber 24 is defined by the tubular portion 21 and the plate portion 22 of the upper casing 20 and the lower casing 30. Specifically, an opening 240 of the pump chamber 24 of the upper casing 20 is closed with the lower casing 30.

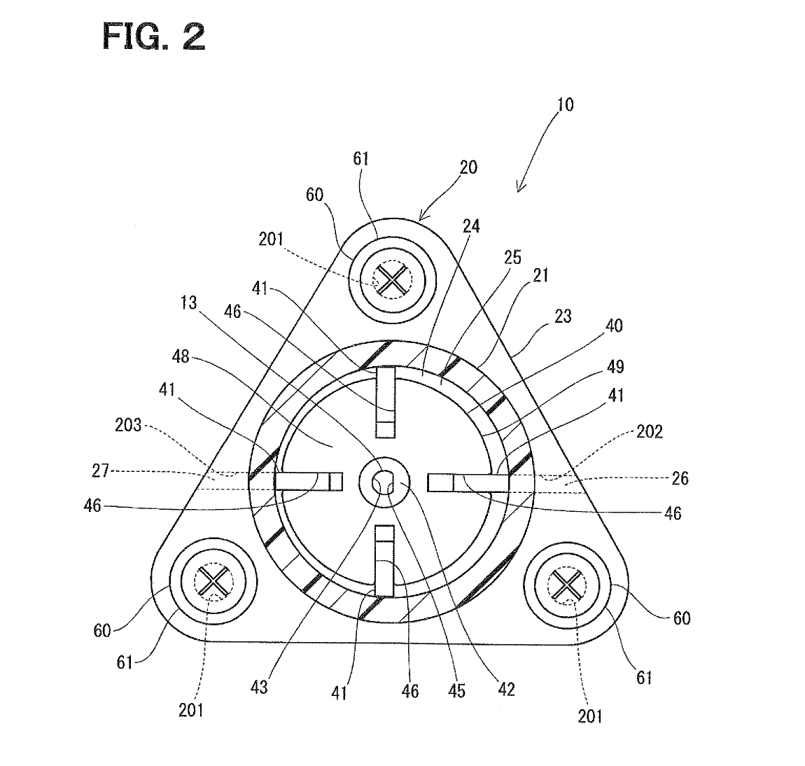

The rotor 40 is configured into a generally cylindrical form and is made of, for example, a resin material. The rotor 40 is rotatably received in the pump chamber 24. Thereby, a space 25 is defined by the tubular portion 21 and the plate portion 22 of the upper casing 20, the lower casing 30 and the rotor 40 (see FIG. 2). In the present embodiment, the rotor 40 is eccentric to a center axis of the tubular portion 21. Therefore, a volume (radial size) of the space 25, which is radially defined between the tubular portion 21 and the rotor 40, changes in the circumferential direction. The space 25 is communicated with a fluid inlet passage 26 and a fluid outlet passage 27. The fluid inlet passage 26 and the fluid outlet passage 27 radially outwardly extend from the space 25. The fluid inlet passage 26 is formed between a groove 202 of the flange portion 23 and the lower casing 30. The fluid outlet passage 27 is formed between a groove 203 of the flange portion 23 and the lower casing 30.

A recess 42 and a center hole 43 are formed in a center part of the rotor 40. The recess 42 is recessed from an end surface of the rotor 40, which is located at the plate portion 22 side, to an axial intermediate part of the rotor 40. Thereby, the recess 42 serves as a material (resin) volume reducing part, which reduces the material (resin) of the rotor 40. The center hole 43 extends through the rotor 40 in a thickness direction (axial direction parallel to the rotational axis) of the rotor 40. Therefore, the center hole 43 connects between the recess 42 of the rotor 40 and the lower casing 30 side of the rotor 40. The center hole 43 includes a tapered hole (tapered hole section) 44, which has a diameter that is progressively reduced from a lower casing 30 side end part to an axial intermediate part of the center hole 43. Furthermore, the center hole 43 also includes a non-circular hole (non-circular hole section) 45, which has a non-circular cross section and extends from the axial intermediate part of the center hole 43 to the recess 42.

The shaft 13 of the motor 11 is received in the center hole 43. When the shaft 13 is inserted into the center hole 43 of the rotor 40, the shaft 13 is guided along the tapered hole 44 and is then received into the non-circular hole 45. The cross section of the shaft 13 generally coincides with the cross section of the non-circular hole 45 in an axial range between the axial intermediate part of the shaft 13 to the recess 42 side end part of the shaft 13. The cross-sectional area of the non-circular hole 45 is larger than the cross-sectional area of the end part of the shaft 13. That is, a radial gap exists between the inner peripheral wall of the rotor 40, which forms the non-circular hole 45, and the outer peripheral wall of the shaft 13. Therefore, the shaft 13 is loosely fitted to the rotor 40 while the cross section of the shaft 13 corresponds to the cross section of the non-circular hole 45. With this loose fit, when the shaft 13 is rotated, the shaft 13 is rotated together with the rotor 40 without causing relative rotation of the shaft 13 relative to the rotor 40. At this time, the rotor 40 could swing or wobble such that the axis of the rotor 40 is tilted.

The rotor 40 has a plurality of vane receiving grooves 46, each of which is radially inwardly recessed from the outer peripheral surface of the rotor 40. Each vane receiving groove 46 axially extends to connect between the lower casing 30 side end surface and the plate portion 22 side end surface of the rotor 40. In the present embodiment, the vane receiving grooves 46 include four vane receiving grooves 46, which are arranged one after another at generally equal intervals in the circumferential direction of the rotor 40. In the rotor 40, each vane receiving groove 46 receives a corresponding one of a plurality of vanes 41. The rotor 40 is eccentric to the inner peripheral wall 211 of the tubular portion 21. Therefore, a radial distance between the rotor 40 and the inner peripheral wall 211 of the tubular portion 21 changes in response to the rotation of the rotor 40. When the rotor 40 is rotated, each vane 41 is radially outwardly pulled by the centrifugal force until the vane 41 contacts the inner peripheral wall 211. When the radial distance between the rotor 40 and the inner peripheral wall 211 of the tubular portion 21 is reduced, each corresponding vane 41 is radially inwardly urged in the corresponding vane receiving groove 46. Thereby, when the rotor 40 is rotated, each vane 41 is rotated together with the rotor 40 while the radially outer end part of each vane 41 slidably contacts the inner peripheral wall 211 of the tubular portion 21. Also, at this time, each vane 41 is reciprocated in the vane receiving groove 46 as the rotor 40 is rotated.

The flange portion 23 of the upper casing 20 includes a plurality of through holes (serving as primary holes) 201, which penetrate through the flange portion 23 in the axial direction. In the present embodiment, the through holes 201 of the flange portion 23 include three through holes 201.

The lower casing 30 has a plurality of projections 31, each of which axially projects toward the motor 11 side and is located at a corresponding location, which corresponds to the corresponding one of the through holes 201 of the upper casing 20. At the center of each projection 31, a through hole (serving as a secondary through hole) 32 penetrates through the lower casing 30 in a thickness direction (axial direction parallel to the rotational axis of the rotor 40) of the lower casing 30. Each through hole 32 is formed at the location, which corresponds to, i.e., axially aligned with the through hole 201. A projecting amount (projecting extent) h of the projection 31 is smaller than a thickness of the resilient sheet 50 in a non-compressed state, i.e., a relaxed state of the resilient sheet 50.

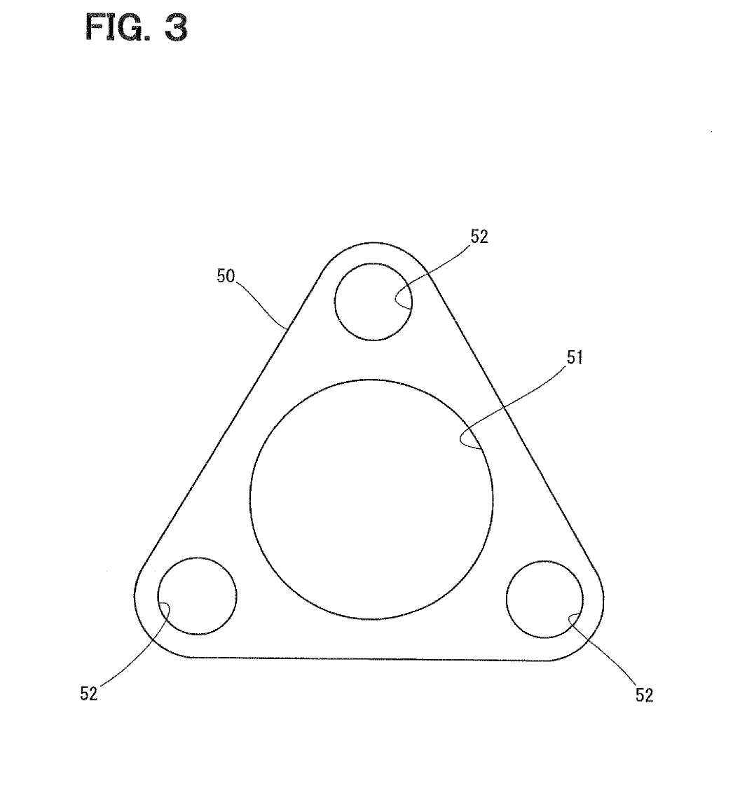

The resilient sheet 50 is placed between the lower casing 30 and the mount portion 14 of the motor 11. The resilient sheet 50 is configured into a plate form (sheet form) and is formed from a material (e.g., rubber), which has a resiliency and a large attenuation coefficient. As shown in FIG. 3, the resilient sheet 50 has a center through hole 51, which penetrates through a center part of the resilient sheet 50 in a thickness direction of the resilient sheet 50 (axial direction of the rotor 40). An inner diameter of the through hole 51 is generally the same as the inner diameter of the pump chamber 24, i.e., the inner diameter of the opening of the other end part of the tubular portion 21 of the upper casing 20, which is located at the lower casing 30 side. Thereby, the resilient sheet 50 is configured into the shape, which corresponds to the shape of the planar surface portion 204 of the upper casing 20.

The resilient sheet 50 has three through holes (serving as tertiary through holes) 52 that are provided at three locations, respectively, which correspond to the projections 31, respectively, of the lower casing 30. An inner diameter of each through hole 52 is generally the same as or slightly larger than the outer diameter of the corresponding projection 31.

As shown in FIG. 1, each of a plurality of screws (serving as screw members) 60 has a head 61 at one end part thereof. A male thread 62 is formed along an outer peripheral surface of the screw 60 to extend from the other end part of the screw 60, which is opposite from the head 61, to an axial intermediate part of the screw 60. The mount portion 14 of the motor 11 is made of, for example, a metal material. The mount portion 14 has three mount holes 15 at three locations, respectively, which correspond to the through holes 201, respectively, of the upper casing 20. A female thread 16, which corresponds to the male thread 62 of the corresponding screw 60, is formed in an inner peripheral wall of each mount hole 15 of the mount portion 14.

Each screw 60 is received through the corresponding through hole 201 of the upper casing 20, the corresponding through hole 32 of the lower casing 30 and the corresponding through hole 52 of the resilient sheet 50 and is threadably engaged with the mount hole 15 of the mount portion 14. In this way, the upper casing 20, the lower casing 30 and the resilient sheet 50 are held between the head 61 of each screw 60 and the mount portion 14 and are thereby securely fitted to the mount portion 14. At this time, an axial force is exerted between the head 61 of the screw 60 and the mount portion 14. Therefore, the resilient sheet 50 is urged by the lower casing 30 and the mount portion 14, so that the resilient sheet 50 is compressed in the axial direction. Thereby, a reaction force is generated at the resilient sheet 50, so that the lower casing 30 receives the surface pressure from the resilient sheet 50 toward the upper casing 20. As a result, the planar surface portion 301 of the lower casing 30 tightly contacts the planar surface portion 204 of the upper casing 20. Thus, the fluid tightness (the gas tightness or liquid tightness) of the pump chamber 24 is maintained.

The projections 31 of the lower casing 30 are received through the through holes 52, respectively, of the resilient sheet 50 and contact the mount portion 14. As discussed above, the projecting amount h of each projection 31 is smaller than the thickness of the resilient sheet 50 in the non-compressed state, i.e., the relaxed state of the resilient sheet 50. Therefore, when the projection 31 contacts the mount portion 14, the resilient sheet 50 is clamped between and is compressed between the lower casing 30 and the mount portion 14. In this way, the lower casing 30 receives the surface pressure, which is generated by the reaction force of the resilient sheet 50, and the distance between the lower casing 30 (other than the projections 31) and the mount portion 14 is kept constant, i.e., kept to the projecting amount h of the projection 31.

In the present embodiment, as shown in FIG. 1, the lower casing 30 has a recess 322, which is recessed for a predetermined amount away from the rotor 40 in a surface 321 of the lower casing 30, which is opposed to an end surface 47 of the rotor 40 in the direction of the rotational axis of the rotor 40, i.e., in the axial direction. Furthermore, the plate portion 22 of the upper casing 20 has a recess 222, which is recessed for a predetermined amount away from the rotor 40 in a surface 221 of the plate portion 22, which is opposed to the other end surface 48 of the rotor 40 in the direction of the rotational axis of the rotor 40.

The recess 322 of the lower casing 30 includes a generally cylindrical surface 323 and a generally circular bottom surface (circular disk shaped bottom surface) 324 to form a step structure. That is, an outer peripheral part of the recess 322 is defined by the generally cylindrical surface 323, and the outer peripheral edge of the recess 322 is generally circular. Furthermore, the rotor 40 is configured into the generally cylindrical form, as discussed above. Therefore, an outer peripheral wall 49 of the rotor 40 is generally circular, i.e., an outer peripheral edge of the rotor 40 is generally circular. In the axial view of the rotor 40, the outer peripheral edge of the recess 322 is placed radially inward of the outer peripheral edge of the rotor 40. Furthermore, in the axial view of the rotor 40, the outer peripheral edge of the recess 222 of the plate portion 22 is placed radially inward of the outer peripheral edge of the rotor 40.

With the above construction, at the time of rotating the rotor 40, the end surface 47 of the rotor 40 slides on the surface 321 (more specifically, a part of the surface 321 located radially outward of the recess 322) of the lower casing 30. That is, at this time, only the outer peripheral part (radially outer part) of the end surface 47 of the rotor 40 slides on the lower casing 30 at any moment during the rotation of the rotor 40. Furthermore, at this time, only the outer peripheral part (radially outer part) of the end surface 48 of the rotor 40 slides on the plate portion 22 of the upper casing 20.

Desirably, a radial width of the slide surface between the lower casing 30 and the rotor 40 (a distance d1 between the outer peripheral edge of the recess 322 and the outer peripheral edge of the rotor 40) and a radial width of the slide surface between the plate portion 22 and the rotor 40 (a distance between d2 between the outer peripheral edge of the recess 222 and the outer peripheral edge of the rotor 40) are set to corresponding sizes, which can implement the sufficient sealing between each adjacent two of the pump chambers divided with the corresponding vane 41.

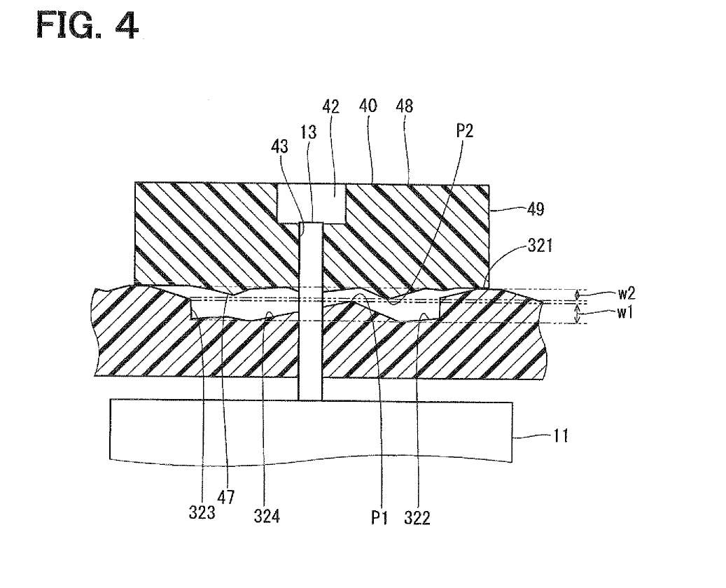

FIG. 4 is a schematic diagram schematically showing only the lower casing 30, the rotor 40, the motor 11 and the shaft 13 of the vane pump 10 of the present embodiment. In this drawing, for descriptive purpose, a surface roughness (waviness) of each corresponding component is exaggerated.

In the present embodiment, in view of a width (axial extent) w1 of the wavy contour of the bottom surface 324 of the lower casing 30 and a width (axial extent) w2 of the wavy contour of the end surface 47 of the rotor 40, the recess 322 is formed such that a distal tip (peak) P1 of a distal end part of the wavy contour of the bottom surface 324, which is closest to the rotor 40, is located on the motor 11 side of a distal tip (peak) P2 of a distal end part of the wavy counter of the end surface 47 of the rotor 40, which is closest to the lower casing 30. That is, in the present embodiment, the recess 322 is recessed for the predetermined amount, so that the distal tip P2 is never located on the motor 11 side of the distal tip P1. Thereby, at the time of rotating the rotor 40, the end surface 47 of the rotor 40 does not contact the bottom surface 324 of the lower casing 30.

The recess 222 of the upper casing 20 is also recessed for the predetermined amount in view of a width (axial extent) of a wavy contour of a bottom surface of the recess 222 of the upper casing 20 and a width (axial extent) of a wavy contour of the end surface 48 of the rotor 40, so that the bottom surface of the recess 222 does not contact the end surface 48 of the rotor 40 during the rotation of the rotor 40.

Next, the operation of the vane pump 10, which is constructed in the above-described manner, will be described.

In response to the rotation of the motor 11, the rotor 40, which is connected to the shaft 13, is rotated. Upon the rotation of the rotor 40, the vanes 41 are rotated together with the rotor 40 such that the vanes 41 slidably contact the inner peripheral wall 211 of the tubular portion 21 during the rotation of the vanes 41. The volume of the space 25 decreases in the rotational direction from the fluid inlet passage 26 side toward the fluid outlet passage 27 side. Therefore, when the vanes 41 are rotated integrally with the rotor 40, the fluid in the space 25 flows from the fluid inlet passage 26 side toward the fluid outlet passage 27 side while being pressurized. In this way, the fluid, which is drawn into the space 25 through the fluid inlet passage 26, is pressurized in the space 25 by the action of the vanes 41 rotated integrally with the rotor 40, and this pressurized fluid is then discharged from the space 25 toward the outside of the vane pump 10 through the fluid outlet passage 27. The fluid is continuously pressurized through the rotation of the rotor 40.

In the present embodiment, when the rotor 40 is rotated, only the outer peripheral part (radially outer part) of the end surface 47 of the rotor 40 slides on the lower casing 30 at any moment. Thereby, the position (posture) of the rotor 40 during the rotation thereof is stabilized, and thereby the pump performance is stabilized.

As discussed above, in the present embodiment, the lower casing 30 has the recess 322, which is recessed for the predetermined amount away from the rotor 40 in the surface 321 of the lower casing 30, which is opposed to the end surface 47 of the rotor 40 in the direction of the rotational axis of the rotor 40. Furthermore, the plate portion 22 of the upper casing 20 has the recess 222, which is recessed for the predetermined amount away from the rotor 40 in the surface 221 of the plate portion 22, which is opposed to the other end surface 48 of the rotor 40 in the direction of the rotational axis of the rotor 40. In the axial view of the rotor 40, the outer peripheral edge of the recess 322 and the outer peripheral edge of the recess 222 are placed radially inward of the outer peripheral edge of the rotor 40. For example, at the time of rotating the rotor 40, the end surface 47 of the rotor 40 slides on the surface 321 (more specifically, the part of the surface 321 located radially outward of the recess 322) of the lower casing 30. That is, at this time, only the outer peripheral part (radially outer part) of the end surface 47 of the rotor 40 slides on the lower casing 30 at any moment. In this way, the position (posture) of the rotor 40 during the rotation thereof is stabilized. Thus, the pump performance is stabilized.

Also, due to the formation of the recess 322 in the lower casing 30 and the recess 222 in the plate portion 22 of the upper casing 20, even when the bottom surface 324 of the recess 222 is rough (wavy), it is possible to limit the contact of such a rough surface (wavy surface) of the bottom surface 324 to the center part of the rotor 40. In this way, it is possible to limit the occurrence of the instable state of the position (posture) of the rotor 40 during the rotation of the rotor 40. Therefore, according to the present embodiment, the stable pump performance can be maintained.

Also, according to the present embodiment, even when the rough surface (wavy surface) is present in the rotor 40 side surface of the lower casing 30 or of the upper casing 20, the rotor 40 can rotate in the stable manner. Therefore, it is not required to increase the surface accuracies (degree of planarity) of the lower casing 30 and of the upper casing 20 during the manufacturing thereof. Thus, the manufacturing of the lower casing 30 and of the upper casing 20 is eased, and thereby the manufacturing costs can be reduced. Therefore, according to the present embodiment, the vane pump, which can maintain the stable pump performance thereof, can be easily manufactured.

Furthermore, according to the present embodiment, the recess 322 and the recess 222 are constructed such that the outer peripheral part of the recess 322, 222 is formed with the generally cylindrical surface to have the step structure. For example, the recess 322, 222 of this configuration can be easily formed with a resin molding die. Therefore, according to the present embodiment, the manufacturing costs required for forming the recesses 322, 222 can be reduced.

In a case where the recesses 322, 222 are formed while the surface flatness of the lower casing 30 and of the plate portion 22 of the upper casing 20 is maintained at, for example, 25 μm in view of a shutoff pressure of the vane pump 10, the accurate manufacturing technique (processing technique) is required. Therefore, in such a case, it is desirable to have the step structures of the recess 322 and of the recess 222. In the case where the recess 322 and the recess 222 are configured to have the step structure, the manufacturing (processing) of the recesses 322, 222 is relatively easy.

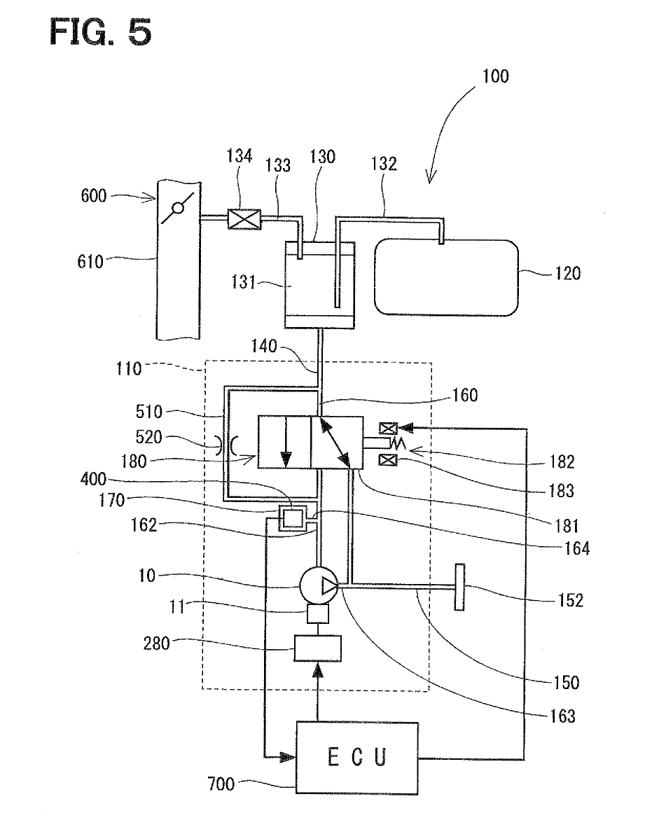

Next, an evaporative leak check system (hereinafter, simply referred to as a check system) 100 having the vane pump 10 of the first embodiment will be described with reference to FIG. 5. In this check system 100, the vane pump 10 is used to depressurize an interior of a fuel tank 120.

The check system 100 includes a check module 110, the fuel tank 120, a canister 130, an air intake apparatus 600 and an ECU 700. The check module 110 includes the vane pump 10, the motor 11, a control circuit 280, a switch valve 180 and a pressure sensor 400. The switch valve 180 and the canister 130 are connected with each other through a canister passage 140. An atmosphere communication passage 150 is open to the atmosphere through an open end 152, which is opposite from the check module 110. The canister passage 140 and the atmosphere communication passage 150 are connected with each other through a connection passage 160. The connection passage 160 and the fluid inlet passage 26 of the vane pump 10 are connected with each other through a pump passage 162. The fluid outlet passage 27 of the vane pump 10 and the atmosphere communication passage 150 are connected with each other through a discharge passage 163. A pressure introducing passage 164 is branched from the pump passage 162, and the pressure introducing passage 164 connects between the pump passage 162 and a sensor chamber 170. The pressure sensor 400 is placed in the sensor chamber 170. With the above construction, the pressure of the sensor chamber 170 becomes generally the same as the pressure of the pressure introducing passage 164 and the pressure of pump passage 162.

An orifice passage 510 is branched from the canister passage 140. The orifice passage 510 connects between the canister passage 140 and the pump passage 162. An orifice 520 is placed in the orifice passage 510. A size of an opening of the orifice 520 is set to allow leakage of a permissible amount of air containing fuel vapor from the fuel tank 120.

The switch valve 180 includes a valve main body 181 and a drive device 182. The drive device 182 drives the valve main body 181. The drive device 182 includes a coil 183, which is connected to the ECU 700. The ECU 700 enables and disables the electric power supply to the coil 183. In the case where the electric power is not supplied to the coil 183, the connection passage 160 and the pump passage 162 are disconnected from each other, and the canister passage 140 and the atmosphere communication passage 150 are connected with each other through the connection passage 160. In contrast, in the case where the electric power is supplied to the coil 183, the canister passage 140 and the pump passage 162 are connected with each other, and the canister passage 140 and the atmosphere communication passage 150 are disconnected from each other. The orifice passage 510 and the pump passage 162 are always connected with each other regardless of whether the electric power is supplied to the coil 183 or not.

The canister 130 includes adsorbent 131, such as activated carbon. The canister 130 is placed between the check module 110 and the fuel tank 120 and adsorbs the fuel vapor generated in the fuel tank 120. The canister 130 is connected to the check module 110 through the canister passage 140 and is connected to the fuel tank 120 through a tank passage 132. Furthermore, the canister 130 is connected to a purge passage 133, which is in turn connected to an intake pipe 610 of the air intake apparatus 600. When the fuel vapor, which is generated in the fuel tank 120, passes through the tank passage 132, the adsorbent 131 adsorbs the fuel vapor. A purge valve 134 is placed in the purge passage 133, which connects between the canister 130 and the intake pipe 610 of the air intake apparatus 600. The purge valve 134 opens or closes the purge passage 133 according to a command received from the ECU 700.

The pressure sensor 400 senses a pressure of the sensor chamber 170 and outputs a signal, which corresponds to the sensed pressure, to the ECU 700. The ECU 700 is a microcomputer, which includes a CPU, a ROM and a RAM (not shown). The ECU 700 receives signals, which are outputted from various sensors that include the pressure sensor 400. The ECU 700 controls the corresponding components according to a predetermined control program, which is stored in the ROM, based on these signals.

The electric power is not supplied to the coil 183 during the operation of the engine and also during a predetermined time period after the time of stopping the engine, so that the canister passage 140 and the atmosphere communication passage 150 are connected with each other through the connection passage 160. Therefore, the air, which contains the fuel vapor generated in the fuel tank 120, passes through the canister 130, and the fuel vapor is removed from the air at the canister 130. Thereafter, the air, from which the fuel vapor is removed, is released to the atmosphere through the open end 152 of the atmosphere communication passage 150.

Upon elapsing of the predetermined time period from the time of stopping the engine of the vehicle, the check operation for checking a leakage of the air, which contains the fuel vapor from the fuel tank 120, starts. In the check operation, the atmospheric pressure is sensed for the purpose of correcting an error caused by an altitude of a location where the vehicle is parked. The atmospheric pressure is sensed with the pressure sensor 400, which is placed in the sensor chamber 170. When the electric power is not supplied to the coil 183, the atmosphere communication passage 150 and the pump passage 162 are connected with each other through the orifice passage 510. The pressure of the sensor chamber 170, which is connected to the pump passage 162 through the pressure introducing passage 164, is generally the same as the atmospheric pressure. Therefore, the atmospheric pressure is sensed with the pressure sensor 400 placed in the sensor chamber 170.

After completion of the sensing of the atmospheric pressure, the altitude of the location, at which the vehicle is parked, is computed based on the sensed atmospheric pressure. The ECU 700 corrects various parameters based on the computed altitude. Upon completion of the correction of the various parameters, the ECU 700 supplies the electric power to the coil 183 of the switch valve 180. When the electric power is supplied to the coil 183, the valve main body 181 of the switch valve 180 is driven toward the right side in FIG. 5. Thereby, the switch valve 180 closes the connection between the atmosphere communication passage 150 and the canister passage 140 and opens the connection between the canister passage 140 and the pump passage 162. Therefore, the sensor chamber 170, which is connected to the pump passage 162, is connected to the fuel tank 120 through the canister 130. In the case where the fuel vapor is generated in the fuel tank 120, the pressure of the interior of the fuel tank 120 is higher than the atmospheric pressure around the vehicle.

When the pressure increase, which is caused by the generation of the fuel vapor in the fuel tank 120, is sensed, the ECU 700 stops the electric power supply to the coil 183 of the switch valve 180. When the electric power supply to the coil 183 is stopped, the pump passage 162 is connected to the canister passage 140 and the atmosphere communication passage 150 through the orifice passage 510. Furthermore, the canister passage 140 and the atmosphere communication passage 150 are connected with each other through the connection passage 160.

At this stage, when the electric power is supplied to the motor 11 through the control circuit 280, the vane pump 10 is driven. Thereby, the pump passage 162 is depressurized. Thus, the air, which is supplied from the atmosphere communication passage 150, flows to the pump passage 162 through the orifice passage 510. The flow of the air, which is supplied to the pump passage 162, is throttled, i.e., choked through the orifice 520 of the orifice passage 510, so that the pressure of the pump passage 162 is reduced. The pressure of the pump passage 162 is reduced to a predetermined pressure, which corresponds to a cross-sectional area of the opening of the orifice 520, and thereafter becomes constant. At this time, the sensed pressure of the pump passage 162 is recorded, i.e., stored as a reference pressure. Upon completion of the sensing of the reference pressure, the electric power supply to the motor 11 is stopped.

Once the reference pressure is sensed, the electric power is supplied to the coil 183 of the switch valve 180 again. In this way, the connection between the atmosphere communication passage 150 and the canister passage 140 is closed, and the connection between the canister passage 140 and the pump passage 162 is opened. Therefore, the fuel tank 120 and the pump passage 162 are connected with each other, and the pressure of the pump passage 162 becomes the same as the pressure of the fuel tank 120. Then, when the electric power is supplied to the motor 11 through the control circuit 280, the vane pump 10 is driven. When the vane pump 10 is driven, the interior of the fuel tank 120 is depressurized. At this time, the pump passage 162 is connected to the fuel tank 120. Therefore, the pressure, which is sensed with the pressure sensor 400 placed in the sensor chamber 170 that is connected to the pump passage 162, is generally the same as the pressure of the interior of the fuel tank 120.

When the pressure of the sensor chamber 170, i.e., the pressure of the interior of the fuel tank 120 becomes lower than the reference pressure through the continuous operation of the vane pump 10, it is determined that a level of the leakage of the air, which contains the fuel vapor generated from the fuel tank 120, becomes equal to or smaller than a permissible threshold level. That is, when the pressure of the interior of the fuel tank 120 is reduced below the reference pressure, it is assumed that the air is not introduced from the outside into the interior of the fuel tank 120, or the flow quantity of the air introduced from the outside into the interior of the fuel tank 120 is equal to or smaller than the flow quantity of the air passing through the orifice 520. Therefore, it is determined that a sufficient level of the airtightness of the fuel tank 120 is maintained.

In contrast, when the pressure of the interior of the fuel tank 120 is not reduced to the reference pressure, it is determined that the leakage of the air containing the fuel vapor from the fuel tank 120 is above the permissible threshold level. That is, when the pressure of the interior of the fuel tank 120 is not reduced to the reference pressure, it is assumed that the air is introduced from the outside into the interior of the fuel tank 120 in response to the depressurization of the interior of the fuel tank 120. Therefore, it is determined that the sufficient level of the airtightness of the fuel tank 120 is not maintained.

Upon completion of the check operation for checking the leakage of the air, which contains the fuel vapor, the electric power supply to the motor 11 and the switch valve 180 is stopped. When the ECU 700 senses that the pressure of the pump passage 162 is returned to the atmospheric pressure, the ECU 700 stops the operation of the pressure sensor 400 and terminates the check process.

As discussed above, the vane pump 10 of the first embodiment can maintain the stable pump performance. Therefore, in the case where the vane pump 10 of the first embodiment is applied to the check system 100, the vane pump 10, which can maintain the stable pump performance, can be used for the purpose of depressurizing the interior of the fuel tank 120. As a result, the stable check performance can be maintained in the check system 100.

### Second Embodiment

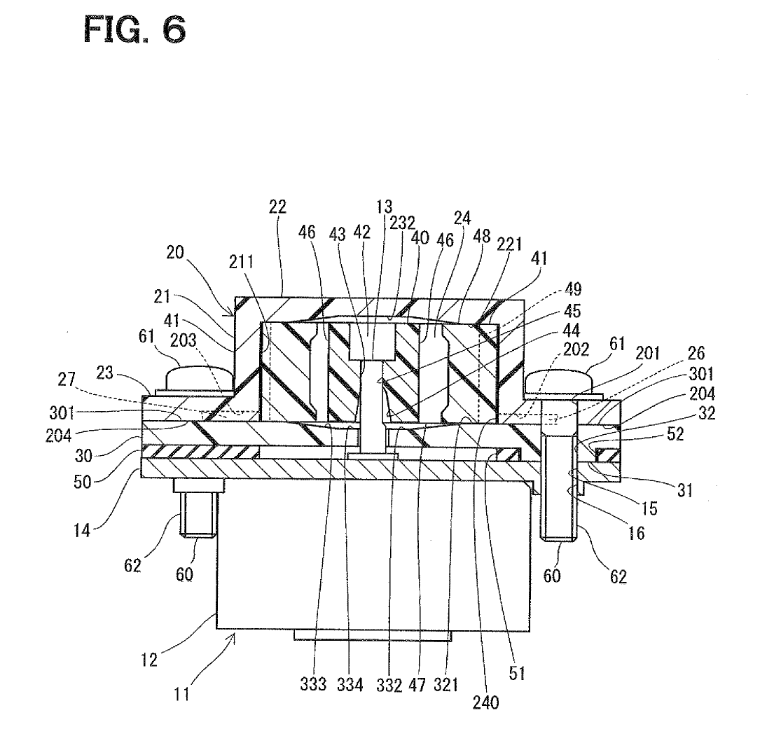

FIG. 6 shows a vane pump according to a second embodiment of the present invention. In the second embodiment, the shape of the recess formed in the lower casing and the shape of the recess formed in the plate portion of the upper casing are different from those of the first embodiment.

In the second embodiment, the lower casing 30 has a recess 332, which is recessed for a predetermined amount away from the rotor 40 in the surface 321 of the lower casing 30 that is opposed to the end surface 47 of the rotor 40 in the direction of the rotational axis of the rotor 40. Furthermore, the plate portion 22 of the upper casing 20 has a recess 232, which is recessed for a predetermined amount away from the rotor 40 in the surface 221 of the plate portion 22 that is opposed to the other end surface 48 of the rotor 40 in the direction of the rotational axis of the rotor 40.

The recess 332 of the lower casing 30 includes a tapered surface 333 of a generally annular shape and a bottom surface 334 of a generally circular shape (a circular disk shape) and is configured into a bowl shape. That is, an outer peripheral part of the recess 332 is defined by the tapered surface 333 of the generally annular shape, and the outer peripheral edge of the recess 332 is generally circular. In the axial view of the rotor 40, the outer peripheral edge of the recess 332 is placed radially inward of the outer peripheral edge of the rotor 40. Furthermore, in the axial view of the rotor 40, the outer peripheral edge of the recess 232 of the plate portion 22 is placed radially inward of the outer peripheral edge of the rotor 40.

Thereby, at the time of rotating the rotor 40, the end surface 47 of the rotor 40 slides on the surface 321 of the lower casing 30. That is, at this time, only the outer peripheral part (radially outer part) of the end surface 47 of the rotor 40 slides on the lower casing 30 at any moment. Furthermore, at this time, only the outer peripheral part (radially outer part) of the end surface 48 of the rotor 40 slides on the plate portion 22 of the upper casing 20.

As discussed above, in the present embodiment, the lower casing 30 has the recess 332, which is recessed for the predetermined amount away from the rotor 40 in the surface 321 of the lower casing 30 that is opposed to the end surface 47 of the rotor 40 in the direction of the rotational axis of the rotor 40. Furthermore, the plate portion 22 of the upper casing 20 has the recess 232, which is recessed for the predetermined amount away from the rotor 40 in the surface 221 of the plate portion 22 that is opposed to the other end surface 48 of the rotor 40 in the direction of the rotational axis of the rotor 40. In the axial view of the rotor 40, the outer peripheral edge of the recess 332 and the outer peripheral edge of the recess 232 are placed radially inward of the outer peripheral edge of the rotor 40. For example, at the time of rotating the rotor 40, the end surface 47 of the rotor 40 slides on the surface 321 (more specifically, a part of the surface 321 located radially outward of the recess 332) of the lower casing 30. That is, at this time, only the outer peripheral part (radially outer part) of the end surface 47 of the rotor 40 slides on the lower casing 30 at any moment. In this way, the position (posture) of the rotor 40 during the rotation thereof is stabilized. Thus, the pump performance is stabilized.

Furthermore, according to the present embodiment, the recess 332 and the recess 232 are constructed such that the outer peripheral part of the recess 332, 232 is formed with the tapered surface 333 of the generally annular shape. Thereby, the recess 332, 232 is configured into the bowl shape. Thus, a volume of the space defined between the rotor 40 and the recess 332 or the recess 232 can be made as small as possible. Specifically, it is possible to avoid the formation of the space of an excessive volume between the rotor 40 and the lower casing 30 or the plate portion 22. In this way, the leakage of the fluid at the pump interior can be reduced or alleviated. As a result, according to the present embodiment, even when the recesses 332, 232 are formed to maintain the stable pump performance, it is possible to limit the increase in the leakage of the fluid in the pump interior.

Now, modifications of the above embodiments will be described.

As a modification of the above embodiments, the recess may be formed in only one of the lower casing and the plate portion of the upper casing.

Furthermore, in each of the above embodiments, each recess may be formed by, for example, urging a cutting tool to the rotor side surface of the lower casing or of the plate portion of the upper casing.

In the above embodiments, the outer peripheral edge of each of the recesses is generally circular. Alternatively, in a modification of the above embodiments, the outer peripheral edge of any one or more the recesses may be configured to have an elliptical shape or a polygonal shape as long as the outer peripheral edge of the recess is located radially inward of the outer peripheral edge of the rotor.

In another modification of the above embodiments, the plate portion of the upper casing and the tubular portion may be formed separately instead of being formed integrally.

In the above embodiment, the present invention is applied to the check system, which is used to check the leakage of the fuel vapor by depressurizing the interior of the fuel tank. Alternatively, the present invention may be applied to a check system, which is used to check the leakage of fuel by pressuring the interior of the fuel tank. Further alternatively, the present invention may be applied to various known apparatuses or systems, which involve depressurization or pressurization of fluid.

As discussed above, the present invention is not limited to the above embodiments, and the above embodiments and the modifications thereof may be further modified within the spirit and scope of the present invention.

What is claimed is:

1. A vane pump comprising:
an upper casing that is cup-shaped and thereby includes a tubular portion and a plate portion, wherein the plate portion is generally planar and closes an opening of one end part of the tubular portion;
a lower casing that is generally planar and closes an opening of the other end part of the tubular portion, which is opposite from the one end part of the tubular portion, to form a pump chamber in corporation with the plate portion and the tubular portion;
a rotor that is generally cylindrical and is rotatably received in the pump chamber, wherein the rotor includes a center hole, which penetrates through a center part of the rotor in an axial direction of the rotor, and a plurality of vanes, which are slidable along an inner peripheral wall of the tubular portion upon rotation of the rotor; and
an electric motor that has a shaft, which is loosely received in the center hole of the rotor, wherein:
the electric motor is driven to rotate the rotor through rotation of the shaft upon receiving electric power;
at least one of a surface of the lower casing and a surface of the plate portion, each of which is opposed to a corresponding end surface of the rotor in the axial direction of the rotor, has a recess that is recessed for a predetermined amount away from the rotor in the axial direction of the rotor; and
an outer peripheral edge of the recess of the at least one of the surface of the lower casing and the surface of the plate portion is placed radially inward of an outer peripheral edge of the rotor in an axial view of the rotor.

2. The vane pump according to claim 1, wherein an outer peripheral part of the recess of the at least one of the surface of the lower casing and the surface of the plate portion has a generally cylindrical surface and thereby forms a step.

3. The vane pump according to claim 1, wherein an outer peripheral part of the recess of the at least one of the surface of the lower casing and the surface of the plate portion has a generally annular tapered surface and thereby has a bow shape.

4. An evaporative leak check system comprising the vane pump of claim 1, which is adapted to depressurize or pressurize an interior of a fuel tank to check leakage of fuel vapor from the fuel tank.
